(19) United States
(12) Patent Application Publication
(10) Pub. No.: US 2026/0197173 A1
(43) Pub. Date: Jul. 9, 2026

(54) Zero-Knowledge Influence Verifier for Privacy-Preserving Proof of Trust Credentials

(71) Applicant: George William Bickerstaff, III, Greenwich, CT (US)

(72) Inventor: George William Bickerstaff, III, Greenwich, CT (US)

(21) Appl. No.: 19/309,653

(22) Filed: Aug. 26, 2025

(51) Int. Cl. H04L 9/32

(52) U.S. Cl. CPC H04L 9/3218

(57) ABSTRACT

The Zero-Knowledge Influence Verifier validates hierarchical influence by aggregating multi-source influence metrics, stacking them hierarchically to compute cumulative trust scores, verifying authenticity using zero-knowledge proofs, auditing outcomes for compliance, and outputting validated results via a secure interface. It includes an influence input module for data ingestion, a stacking processor for layered scoring, a verification engine for cryptographic validation, an audit logger for compliance records, and an output interface for secure delivery. The method ingests metrics, stacks hierarchically, verifies influence, audits results, and delivers outputs for applications like reputation management and blockchain governance. This invention addresses fragmented influence validation by enabling secure, privacy-preserving trust across distributed networks, ensuring GDPR compliance and interoperability.

### CROSS-REFERENCE TO RELATED APPLICATIONS

This application claims the benefit of U.S. Provisional Ser. No. 63/847,299, filed on Jul. 20, 2025, the entire contents of which are incorporated herein by reference.

### CPC CLASSIFICATIONS

G06Q 50/01 (organizational management; social networking)
G06F 16/9535 (structured data optimization)
H04L 9/32 (cryptographic mechanisms)
G06N 20/00 (machine learning applications)
H04L 9/00 (zero-knowledge proof systems)

### DEFINITIONS

For clarity and accurate interpretation, the following terms are defined as used in this specification:
Audit Logger: A system component that records all influence stacking operations, verification outcomes, and compliance details for traceability and regulatory audits.
Hierarchical Influence: Structured authority and trust derived from layering influence metrics, where higher layers enhance validation based on lower-layer reliability.
Influence Stacking: The process of aggregating and layering multiple influence metrics from diverse sources in a hierarchical structure to compute a cumulative trust profile.
Verification Engine: A component that authenticates stacked influence metrics using zero-knowledge cryptographic methods and predefined trust metrics to ensure accuracy and privacy.
Zero-Knowledge Proof: A cryptographic method allowing validation of influence metrics without revealing underlying data, ensuring privacy and security.

### FIELD OF THE INVENTION

This invention relates to data processing systems for validating influence metrics through hierarchical stacking and zero-knowledge proofs, with applications in reputation management, blockchain governance, and distributed network systems.

### BACKGROUND OF THE INVENTION

Influence validation in digital ecosystems often processes metrics individually, failing to account for hierarchical relationships where multiple layers contribute to overall trust.

This leads to fragmented trust recognition, inefficiencies in cross-platform verification, and increased fraud risks.

As decentralized and blockchain-based systems grow, a stacking engine with zero-knowledge capabilities is needed to aggregate, layer, and verify influence metrics securely.

Prior art offers solutions for influence aggregation and identity management but lacks hierarchical stacking with robust auditing and zero-knowledge privacy.

The following table summarizes key prior art and their limitations, verified through patent database searches (USPTO, Google Patents, August 2025):

(Your table remains unchanged.)

These prior arts advance blockchain and trust scoring but fail to provide a comprehensive system for hierarchical influence stacking, zero-knowledge verification, auditing, and secure output, which this invention addresses through a structured engine with layered processing and privacy-preserving features.

### SUMMARY OF THE INVENTION

The Zero-Knowledge Influence Verifier provides a system and method for hierarchical influence validation by aggregating multi-source influence metrics, stacking them to compute cumulative trust scores, verifying authenticity with zero-knowledge proofs, auditing outcomes for compliance, and delivering secure outputs.

The system includes an influence input module with aggregation and privacy filters, a stacking processor for hierarchical layering and proof generation, a verification engine for zero-knowledge validation, an audit logger for immutable compliance records, and an output interface for secure, privacy-preserving delivery.

The method ingests metrics, stacks hierarchically, verifies using zero-knowledge techniques, audits for traceability, and outputs verifiable results for applications like decentralized reputation management and blockchain governance.

Advantages include enhanced privacy through zero-knowledge proofs, reduced fraud via layered verification, GDPR compliance, transparent auditing, and scalable interoperability in trust ecosystems.

### BRIEF DESCRIPTION OF THE DRAWINGS

The drawings illustrate embodiments of the invention and are not intended to limit the scope thereof.

FIG. 1 illustrates the system architecture overview of the influence input module, including data inputs, aggregation unit, privacy filter, source verifier, and metric classifier.

FIG. 2 illustrates the stacking processing pipeline of the stacking processor, including hierarchical layering, weight assignment, cumulative scoring, layer integration, and zero-knowledge proof generator.

FIG. 3 illustrates the verification framework of the verification engine, including cumulative checks, authenticity validation, trust metric evaluation, fraud detection, and zero-knowledge validation.

FIG. 4 illustrates the audit logging workflow of the audit logger, including outcome recording, compliance checker, timestamp module, immutable storage, and privacy-preserving audit.

FIG. 5 illustrates the flowchart of output processes of the output interface, including validation delivery, encryption unit, integration API, result formatting, and zero-knowledge output.

### DETAILED DESCRIPTION OF THE INVENTION

The Zero-Knowledge Influence Verifier (ZKIV) is a system and method that enables secure, privacy-preserving validation of hierarchical influence metrics in distributed digital ecosystems.

### Influence Input Module

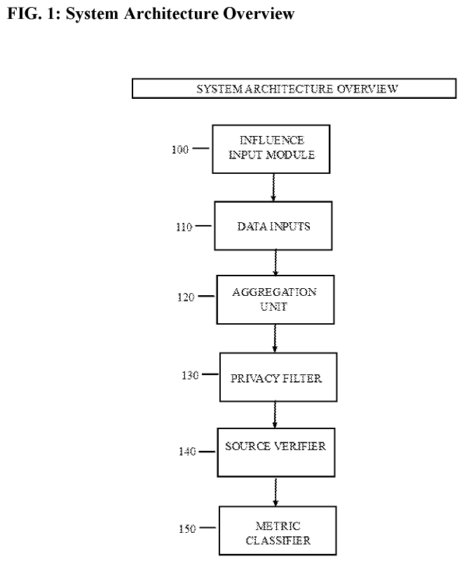

As shown in FIG. 1 with reference 100, the influence input module ingests multi-source data inputs (reference 110) through the aggregation unit (reference 120), which consolidates metrics from sources such as social media, blockchain ledgers, and analytics platforms.

The privacy filter (reference 130) ensures GDPR-compliant data handling by anonymizing sensitive information.

The source verifier (reference 140) authenticates inputs using cryptographic signatures to prevent tampering.

The metric classifier (reference 150) categorizes data for hierarchical processing, enabling efficient downstream stacking.

### Stacking Processor

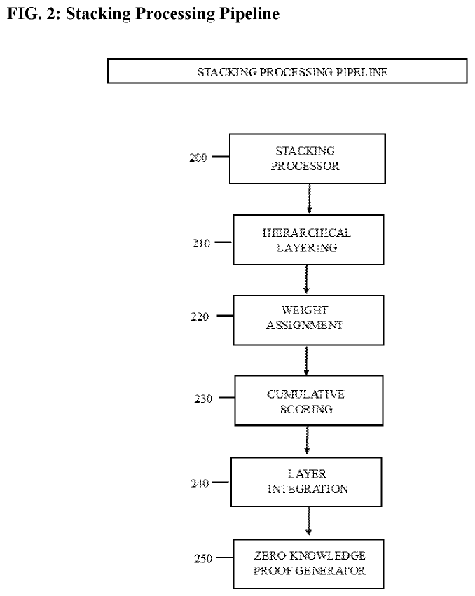

As shown in FIG. 2 with reference 200, the stacking processor performs hierarchical layering (reference 210) to organize metrics into structured levels based on reliability and relevance.

Weight assignment (reference 220) applies dynamic algorithms to prioritize layers.

Cumulative scoring (reference 230) computes aggregated trust profiles.

Layer integration (reference 240) merges the hierarchy into a cohesive model.

The zero-knowledge proof generator (reference 250) creates proofs for verifiable claims without revealing underlying data, ensuring privacy during validation.

### Verification Engine

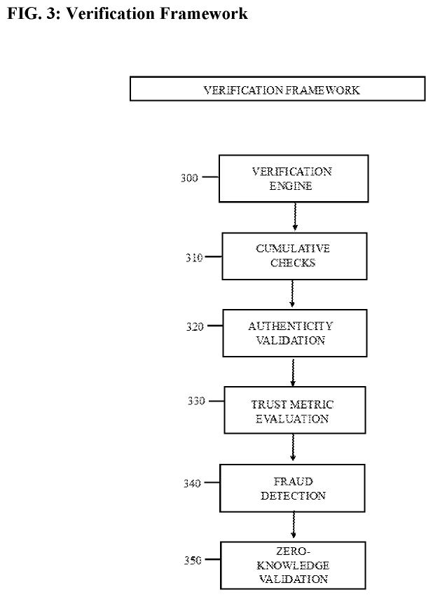

As shown in FIG. 3 with reference 300, the verification engine conducts cumulative checks (reference 310) on stacked scores.

Authenticity validation (reference 320) via cross-references.

Trust metric evaluation (reference 330) using predefined thresholds.

Fraud detection (reference 340) identifies anomalies through pattern analysis.

Zero-knowledge validation (reference 350) confirms integrity without data exposure.

### Audit Logger

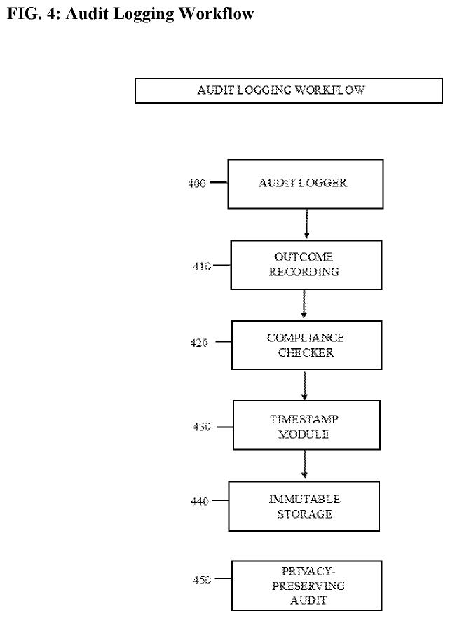

As shown in FIG. 4 with reference 400, the audit logger enables outcome recording (reference 410) of all operations for transparency.

The compliance checker (reference 420) ensures adherence to regulations like GDPR.

The timestamp module (reference 430) logs events chronologically.

Immutable storage (reference 440) uses blockchain for tamper-proof records.

The privacy-preserving audit (reference 450) protects logs while allowing authorized access without compromising sensitive information.

### Output Interface

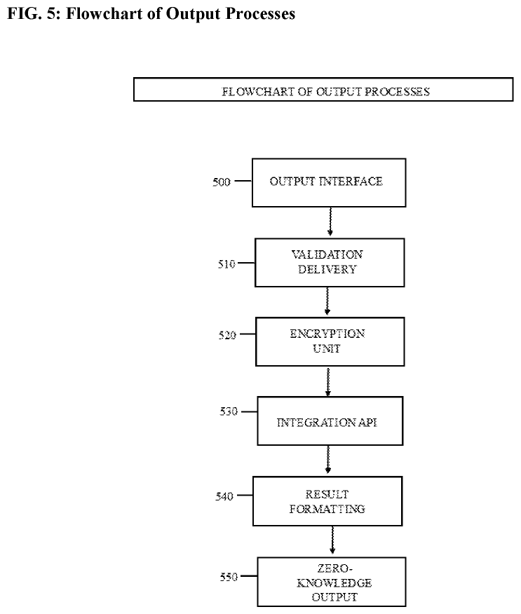

As shown in FIG. 5 with reference 500, the output interface facilitates validation delivery (reference 510) of verified results securely.

The encryption unit (reference 520) protects data in transit.

The integration API (reference 530) enables compatibility with third-party systems.

Result formatting (reference 540) supports outputs in formats like JSON or XML.

The zero-knowledge output (reference 550) provides verifiable certifications without disclosing metrics, ensuring end-to-end privacy.

### Operational Method

The ZKIV operates by:

Ingesting influence metrics through the influence input module (FIG. 1 with reference 100), aggregating via the aggregation unit (reference 120), filtering for privacy (reference 130), verifying sources (reference 140), and classifying metrics (reference 150).

Stacking metrics hierarchically in the stacking processor (FIG. 2 with reference 200), layering (reference 210), assigning weights (reference 220), scoring cumulatively (reference 230), integrating layers (reference 240), and generating zero-knowledge proofs (reference 250).

Verifying influence in the verification engine (FIG. 3 with reference 300), performing cumulative checks (reference 310), validating authenticity (reference 320), evaluating trust metrics (reference 330), detecting fraud (reference 340), and applying zero-knowledge validation (reference 350).

Auditing outcomes via the audit logger (FIG. 4 with reference 400), recording outcomes (reference 410), checking compliance (reference 420), timestamping (reference 430), storing immutably (reference 440), and ensuring privacy-preserving audits (reference 450).

Outputting validations through the output interface (FIG. 5 with reference 500), delivering validations (reference 510), encrypting (reference 520), integrating via API (reference 530), formatting results (reference 540), and providing zero-knowledge outputs (reference 550).

### Advantages

The ZKIV provides structured, privacy-preserving validation, enhances trust portability across platforms, reduces fraud through layered zero-knowledge verification, ensures GDPR compliance, supports scalable interoperability, and enables efficient auditing, making it ideal for decentralized reputation systems and blockchain governance.

What is claimed is:

1. A computerized system for privacy-preserving proof of trust credentials using zero-knowledge proofs, as shown in FIG. 1 with reference 100, comprising: one or more processors; and memory storing instructions that, when executed, cause the system to: ingest multi-source influence metrics via an influence input module as shown in FIG. 1 with reference 100, including aggregation, privacy filtering, source verification, and metric classification; stack the metrics hierarchically via a stacking processor as shown in FIG. 2 with reference 200, including layering, weight assignment, cumulative scoring, layer integration, and zero-knowledge proof generation; verify cumulative influence via a verification engine as shown in FIG. 3 with reference 300, including cumulative checks, authenticity validation, trust metric evaluation, fraud detection, and zero-knowledge validation; log results via an audit logger as shown in FIG. 4 with reference 400, including outcome recording, compliance checking, timestamping, immutable storage, and privacy-preserving auditing; and output validation via an output interface as shown in FIG. 5 with reference 500, including validation delivery, encryption, API integration, result formatting, and zero-knowledge output.

2. A computer-implemented method for privacy-preserving proof of trust credentials using zero-knowledge proofs, as shown in FIG. 1 with reference 100, comprising: ingesting multi-source influence metrics via an influence input module as shown in FIG. 1 with reference 100; stacking the metrics hierarchically via a stacking processor as shown in FIG. 2 with reference 200; verifying cumulative influence via a verification engine as shown in FIG. 3 with reference 300; auditing results via an audit logger as shown in FIG. 4 with reference 400; and outputting validation via an output interface as shown in FIG. 5 with reference 500.

3. A non-transitory computer-readable storage medium storing instructions that, when executed by a processor, cause performance of a method for privacy-preserving proof of trust credentials using zero-knowledge proofs, as shown in FIG. 1 with reference 100, comprising: ingesting multi-source influence metrics via an influence input module as shown in FIG. 1 with reference 100; stacking the metrics hierarchically via a stacking processor as shown in FIG. 2 with reference 200; verifying cumulative influence via a verification engine as shown in FIG. 3 with reference 300; auditing results via an audit logger as shown in FIG. 4 with reference 400; and outputting validation via an output interface as shown in FIG. 5 with reference 500.

4. The system of claim 1, wherein the influence metrics include cross-platform data from social media, blockchain, and analytics platforms, ingested via the influence input module as shown in FIG. 1 with reference 110.

5. The system of claim 1, wherein the stacking combines verified metrics hierarchically with zero-knowledge proof generation as shown in FIG. 2 with reference 250.

6. The system of claim 1, wherein the verification uses zero-knowledge proofs and cryptographic checks for fraud detection as shown in FIG. 3 with reference 340 and reference 350.

7. The system of claim 1, wherein the audits generate immutable, privacy-preserving logs using timestamped records as shown in FIG. 4 with reference 430 and reference 450.

8. The system of claim 1, wherein the outputs support reputation and governance applications with zero-knowledge delivery as shown in FIG. 5 with reference 550.

9. The system of claim 1, wherein the instructions dynamically adapt stacking weights based on source reliability and real-time trends as shown in FIG. 2 with reference 220.

10. The method of claim 2, wherein ingesting includes GDPR-compliant data handling with privacy filters as shown in FIG. 1 with reference 130.

11. The method of claim 2, wherein stacking applies hierarchical algorithms with zero-knowledge proof generation as shown in FIG. 2 with reference 250.

12. The method of claim 2, wherein verifying ensures alignment with trust metrics and fraud detection using zero-knowledge validation as shown in FIG. 3 with reference 330 and reference 350.

13. The method of claim 2, wherein auditing incorporates timestamped, immutable records in privacy-preserving format as shown in FIG. 4 with reference 440 and reference 450.

14. The method of claim 2, wherein outputting delivers encrypted, zero-knowledge certifications via API as shown in FIG. 5 with reference 530 and reference 550.

15. The system of claim 1, further comprising integration of machine learning models in the verification engine for enhanced fraud detection as shown in FIG. 3 with reference 340, wherein the models adapt based on historical validation data without compromising zero-knowledge privacy.

16. The method of claim 2, further comprising generating portable trust profiles from stacked metrics, verifiable across blockchains using the zero-knowledge output as shown in FIG. 5 with reference 550.
